(19) United States
(12) Patent Application Publication
(10) Pub. No.: US 2010/0174401 A1
(43) Pub. Date: Jul. 8, 2010

(54) APPARATUS FOR PROTECTING CLOSED SPACES FROM FLOODING OR CONTAMINATIONS

(76) Inventors: Sergio Giacosa, Calenzano (IT); Edoardo Pini, Calenzano (IT)

Correspondence Address: ABELMAN, FRAYNE & SCHWAB, 666 THIRD AVENUE, 10TH FLOOR, NEW YORK, NY, 10017, US

(21) Appl. No.: 12/450,945

(22) PCT Filed: Apr. 17, 2008
(86) PCT No.: PCT/EP2008/054670

§ 371 Date: Feb. 22, 2010

(30) Foreign Application Priority Data
Apr. 18, 2007 (IT) FI2007A000095

(51) Int. Cl. E06B 7/18; E05F 15/20; G06F 7/00; E06B 5/16; G05B 23/02; F16K 31/02

(52) U.S. Cl. 700/213; 49/31; 340/3.1; 251/129.15

(57) ABSTRACT

An apparatus for protecting closed spaces from flooding or contaminations comprising: a moveable closing element (100) for spaces associated to a corresponding fixed element (101) and adapted to engage therewith during the step of closing; an appropriate peripheral seal (10) with an internal section either hollow or formed by porous material and positioned at the gap existing, in closing position, between said moveable element (100) and the corresponding fixed element (101); at least one transducer element (11), associated to said moveable closing element, adapted to measure the value of one or more physical-chemical parameters; inflation means (13) adapted to modulate the pressure of the fluid contained in the cavity or in the porosity of said seal (10); a control module (12), associated to said at least one transducer element (11) and adapted to drive said inflation means (13).

### FIELD OF THE INVENTION

The present invention relates to the field of devices such as windows, doors and the like, adapted to guarantee tightness in the presence of flooding and, more generally, of contaminations due to the presence of liquids, gases, dust, fumes, etc.

### STATE OF THE ART

The devices currently available for protecting closed spaces from possible flooding or contaminations due to liquid, gaseous or solid contaminants are based on activated systems adapted—by means of a manual or automatic control—to confer to the windows or to the doors closing the space to be protected the possibility of sealing the openings thus avoiding, or at least limiting, the introduction of contaminants through the gaps present either in said window/door or between said window/door and the corresponding opening.

All the currently available devices and systems are based on “ON-OFF” type operating principles, i.e. said devices are alternatively either activated thus supplying the required level or degree of protection, or not active when no protection is required.

The current evolution of the climate, in which there is the possibility of atmospheric phenomena of power, propagation speed and severity which are mostly unpredictable due to the lack of reliable terms of comparison, requires increasingly higher performance devices capable of rapidly reacting with modulatable degrees of protection.

By not offering a modulatable degree of protection, the devices of the known art are subjected in all those cases in which, for example, there is the presence of limited flooding levels, to always operate in maximum performance conditions. For this reason, they are always subjected to early wear, coming up against faults having more than due frequency and energy consumptions of much higher entity than that would be strictly necessary.

Therefore, when activated, the devices of the known art do not have the possibility of modulating their intervention in relation to the real danger of contamination and flooding. It would thus be desirable to provide the existing devices with this possibility so as to make the operation thereof more effective and accurate.

### SUMMARY OF THE INVENTION

The apparatus according to the present invention comprises a window/door, and a corresponding control apparatus, provided with a sealing ring characterized by operativeness proportioned to the pressure caused by the level of flooding or contamination in progress.

### BRIEF DESCRIPTION OF THE DRAWINGS

FIG. 1 First preferred embodiment of the apparatus according to the present invention.

FIG. 2 Block diagram related to a second preferred embodiment of the apparatus according to the present invention.

### DETAILED DESCRIPTION OF THE INVENTION

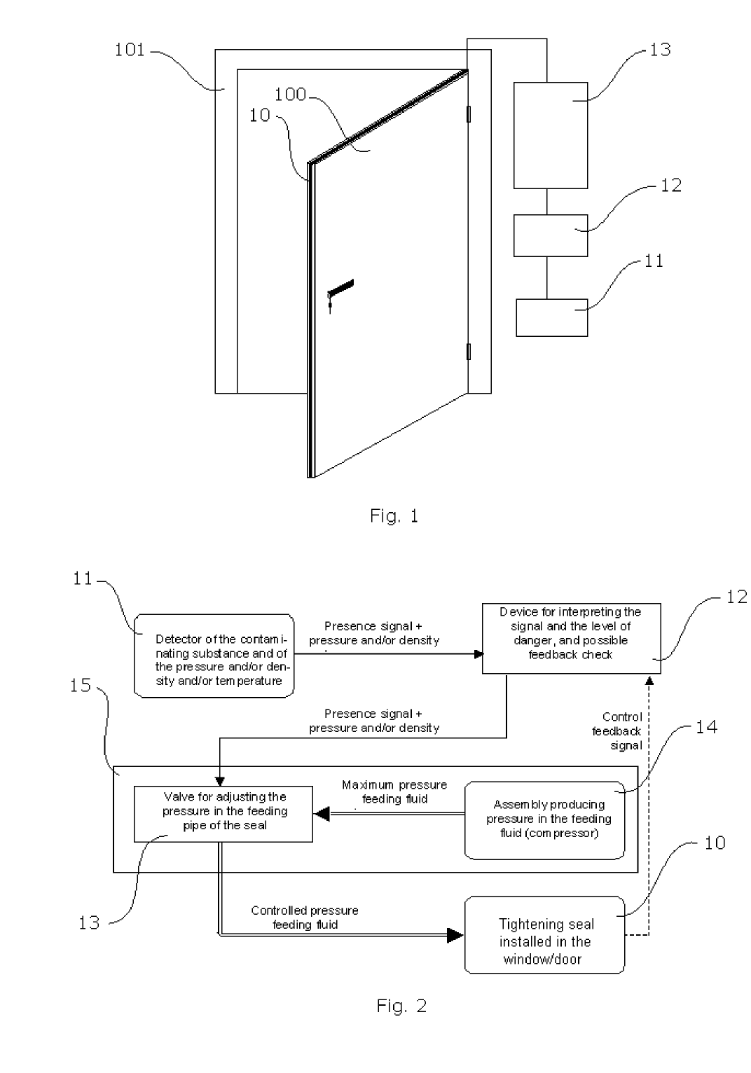

Accompanying FIG. 1 shows a preferred embodiment of the apparatus according to the present invention comprising:
a door, a window or an equivalent moveable closing element 100 for spaces, provided with an appropriate peripheral seal 10, in turn preferably formed by elastic material and positioned at the gap existing between said moveable element and the corresponding fixed element 101 consisting, for example, of a matching frame which can be mounted either on said moveable closing element 100 or on the corresponding fixed element 101. Said peripheral seal is preferably characterized by a waterproof and continuous tubular body provided with an internal section which is either hollow or formed by porous material so as to be able to contain either a compressible fluid (e.g. a gas such as air, nitrogen, etc.) or an incompressible fluid (e.g. a liquid such as water, oil, etc.). In rest conditions, said seal is such to have a reduced section so that said gap is not engaged and thus allows the easy movement of said moveable element;
at least one transducer element 11, associated to said moveable closing element adapted to measure the value of one or more physical-chemical parameters chosen, for example, from the group comprising the pressure, the humidity, the density, the temperature, etc., or the concentration of a certain liquid, gaseous or particulate contaminant;
an appropriate control module 12, associated to said at least one transducer element 11, preferably comprising a device—e.g. of electric, electromechanical or mechanical type—adapted to detect and possibly record information about the status of the monitored physical-chemical parameter or parameters and to convert the signals received from said at least one transducer element into a command, or a series of commands, aimed at actuating
appropriate inflation means 13 adapted to gradually and controllably increase the pressure of the fluid contained in the cavity or in the porosity of said seal, so that the consequent expansion is such to fully occupy the volume of the gap and to exert a pressure on said fixed element represented for example by the window/door frame. The flooding or contamination resistance will thus be proportioned to the entity or to the pressure exerted by the flooding itself.

Said at least one transducer element 11 is preferably positioned in a point in which the presence of the contaminating substance is decisive so as to effectively discriminate whether and how to activate the seal. For this purpose, said at least one transducer element 11 may be advantageously arranged directly on said moveable closing element 100, on its external side but also on its internal side, as occurs for example in all those cases in which the contaminating substance or substances are commonly present outside the space to be protected, but the protections only need to be actuated when they penetrate inside and exceed a predetermined density or a certain concentration threshold. Similarly, said at least one transducer element 11 may be advantageously arranged at a certain distance from said moveable closing element 100, either inside or outside thereof, in points in which the concentration of the possible contaminating substance is predictably significant.

Said at least one transducer element 11 may be further connected to a control module 12 either by means of an electric or optical cable, or by means of a tube containing a transmission fluid, or even by means of wireless communication systems, such as for example electromagnetic waves, infrared rays, etc. according to any of the communication protocols in use in the known art.

Multiple transducer elements may be advantageously used, either of the same or of different types, when there are multiple concerned points for the detection; if the sensors are multiple, the task of interpreting the incoming signals in a combined manner is normally assigned to said control module in order to arrange the appropriate or necessary interventions. Said multiple transducer elements may also be used either for making the system redundant for safety reasons or for evaluating the single or combined action of different contaminating substances. The presence of combinations of certain contaminating substances could indeed discriminate the type of action which must be performed by the seal or seals. Indeed, there may further be provided the possibility of installing seals of different type, e.g. formed by different materials and having different dimensions, to be activated either selectively or in sequence according to the detected contaminating substances.

In this regard, a further preferred embodiment of the present invention includes the use of a smoke-proof, fire-resistant seal adapted to prevent the introduction of smoke and toxic and/or harmful gases produced by a fire, consisting of a hollow tube formed by fire-resistant material, e.g. very thin stainless steel, and comprising longitudinal folds adapted to allow the expansion thereof upon the inflation subsequent to the detection of an alarm condition. Said smoke-proof seal may be installed on its own or in combination with seals of the traditional type and is particularly effective when the alarm condition is caused by flames or by high temperature smoke caused by a fire, condition which may be very dangerous for the seals of the traditional type which melt causing the windows/doors to stick to their frames thus making their subsequent opening impossible, specifically in the case of emergency, this being a very severe aspect of the current fire doors.

Accompanying FIG. 2 shows a block diagram related to a second preferred embodiment of the apparatus according to the present invention wherein said inflation means 13 comprise pressure production means 14 in the fluid adapted to inflate the seal upon a detected emergency state consisting for example of a compressor, and means for adjusting the inflation pressure of the seal 15 consisting, for example, of a valve of the controlled type or a solenoid valve.

The operation of the apparatus provides that under alarm conditions said at least one transducer 11 generates a signal either indicative (in case of ON-OFF type detection) or proportional (in case of proportional type detection) to the concerned detected or measured parameter. The generated signal is transmitted to said control module 12 associated to said at least on transducer element 11, which interprets the received signal and generates in turn a driving signal adapted to adjust the opening of said inflation pressure adjusting means of the seal 15, e.g. consisting of a solenoid valve, which modulates the inflation pressure of the seal intercepting the fluid produced by said pressure production means 14 adapted to make the available pressure always higher than the maximum required inflation pressure. A further pressure sensor may be used to detect the real pressure in the seal and send a feedback signal to said control module 12 for controlling the result and actuating possible corrective actions. Furthermore, said adjustment means of the inflation pressure of the seal 15 may be even manually actuated for the activation/deactivation in case of emergency.

1. An apparatus for protecting closed spaces from flooding or contaminations comprising: a moveable closing element for spaces associated to a corresponding fixed element and adapted to engage therewith during the step of closing; an appropriate peripheral seal with an internal section either hollow or formed by porous material and positioned at the gap existing in closing position between said moveable element and the corresponding fixed element; at least one transducer element, associated to said moveable closing element, adapted to measure the value of one or more physical-chemical parameters; inflation means adapted to modulate the pressure of the fluid contained in the cavity or in the porosity of said seal; a control module, associated to said at least one transducer element and adapted to drive said inflation means.

2. An apparatus according to claim 1, wherein said peripheral seal consists of a waterproof and continuous tubular body adapted to contain an appropriate fluid.

3. An apparatus according to claim 2, wherein said fluid is of the compressible type.

4. (canceled)

5. An apparatus according to claim 2, wherein said fluid is of the incompressible type.

6. (canceled)

7. An apparatus according to claims 1, wherein said peripheral seal is mounted on said moveable closing element.

8. An apparatus according to claims 1, wherein said peripheral seal is mounted on said fixed closing element.

9. An apparatus according to claims 1, wherein said control module comprises a device adapted to detect and possibly record information about the state of the monitored physical-chemical parameter or parameters, and to convert the signals received from said at least one transducer element into a command or a series of commands aimed at actuating said inflation means.

10. An apparatus according to claims 1, wherein said at least one transducer element is connected to said control module by means of an electric or optical type cable.

11. An apparatus according to claims 1, wherein said at least one transducer element is connected to said control module by means of a tube containing a transmission fluid.

12. An apparatus according to claims 1, wherein said at least one transducer element is connected to said control module by means of wireless type communication systems.

13. (canceled)

14. An apparatus according to claim 10, wherein said wireless type communication systems are chosen from the group comprising electromagnetic wave and infrared ray communication systems.

15. An apparatus according to claims 1, wherein said physical-chemical parameters are chosen from the group comprising the pressure, the humidity, the density, the temperature and the concentration of contaminating substances.

16. An apparatus according to claim 1, wherein said contaminating substances are of the liquid, gaseous or particulate type.

17. An apparatus according to claims 1, wherein said peripheral seal comprises a smoke-proof, fire-resistant seal adapted to prevent the introduction of smoke or toxic and/or harmful gases produced by a fire.

18. An apparatus according to claim 14, wherein said smoke-proof type seal comprises a very thin hollow tube formed by fire-resistant material and comprising longitudinal folds adapted to allow the expansion thereof upon the inflation subsequent to the detection of an alarm condition.

19. An apparatus according to claim 15, wherein said smoke-proof type seal is formed by stainless steel.

20. An apparatus according to claims 15, wherein said smoke-proof type seal is associated to one or more traditional type seals.

21. An apparatus according to claims 1, wherein said inflation means comprise pressure production means in the fluid adapted to inflate said seal, and inflation pressure adjustment means of said seal.

22. An apparatus according to claim 18, wherein said inflation pressure adjustment means of said seal comprise a controlled type valve.

23. An apparatus according to claim 18, wherein said inflation pressure adjustment means of said seal comprise a solenoid valve.

24. An apparatus according to claims 18, wherein said inflation pressure adjustment means are of the type adapted to be actuated even manually for the activation/deactivation in case of emergency.

25. An apparatus according to claims 18, wherein said pressure production means comprise a compressor.

26. An apparatus according to claims 1, comprising a further pressure sensor adapted to detect the real pressure present in said seal and to send a feedback signal to said control module.

27. An apparatus according to claims 1, wherein said moveable closing element consists of a door or a window.
